(19) United States
(12) Patent Application Publication
(10) Pub. No.: US 2021/0376630 A1
(43) Pub. Date: Dec. 2, 2021

(54) Tool Charging System

(71) Applicant: HUSQVARNA AB, Huskvarna (SE)

(72) Inventor: Jon FUNK, Moorsville, NC (US)

(21) Appl. No.: 17/286,360

(22) PCT Filed: Oct. 18, 2018
(86) PCT No.: PCT/IB2018/058115

§ 371 Date: Apr. 16, 2021

(51) Int. Cl. H02J 7/00

(52) U.S. Cl. CPC H02J 7/00036; H02J 7/0068; H02J 7/0048; H02J 7/007188

(57) ABSTRACT

A system may be provided. The system may include a tool, a battery pack configured to power the tool, and a battery charger configured to charge the battery pack to a predetermined charge level, the predetermined charge level being less than a full charge level of the battery pack.

### TECHNICAL FIELD

Example embodiments generally relate to a battery-powered tool and, more particularly, to facilitating communication between a battery pack configured to power a tool and a battery charger in order to enable efficient charging of the battery pack by the battery charger.

### BACKGROUND

Various devices or tools configured for the performance of corresponding specific tasks—for example, certain tasks, like grass cutting—may be powered by a battery pack. The battery pack may be configured to be detachable from the device or tool and recharged, as needed.

When the battery pack is depleted or an operator is finished performing a task with the device or tool, the battery pack may be detached from the device or tool and inserted into a battery charger to ensure that the battery pack is fully charged for the next use. In this regard, the battery charger may be configured to supply a continual charging current to the battery pack until the charger detects that the battery pack is at a full charge or the battery pack is removed from the charger.

### BRIEF SUMMARY OF SOME EXAMPLES

Accordingly, in order to facilitate more efficient charging of the battery pack by the battery charger, some example embodiments may provide a battery pack that is configured to communicate to the battery charger certain operational data of the battery pack and the tool the battery pack is powering to allow for the battery charger to adjust the charging duration of the battery pack based on the operational data received. Therefore, the battery charger may be configured to supply only the charge required by the battery pack to enable a longer-life battery pack and greater charging efficiency.

In one example embodiment, a system may be provided. A system may include a tool, a battery pack configured to power the tool, and a battery charger configured to charge the battery pack to a predetermined charge level, the predetermined charge level being less than a full charge level of the battery pack.

In a further example embodiment, a battery pack configured to power a tool may be provided. The battery pack may include processing circuitry configured to receive and analyze operational data associated with the tool and operational data associated with the battery pack. The processing circuitry may be further configured to determine, based on the operational data of the tool and the battery pack, a predetermined charge level of the battery pack sufficient to perform a predetermined next task of the tool, the predetermined charge level being less than a full charge level of the battery pack.

In an even further example embodiment, a method for determining a predetermined charge level of a battery pack configured to power a tool may be provided. The method may include receiving and analyzing operational data associated with the tool and operational data associated with the battery pack. The method may further include determining, based on the operational data of the tool and the battery pack, the predetermined charge level of the battery pack sufficient to perform a predetermined next task of the tool, wherein the predetermined charge level is less than a full charge level of the battery pack.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a concept diagram of a system according to an example embodiment;

FIG. 2 illustrates a block diagram of processing circuitry of a battery pack according to an example embodiment;

FIG. 3 illustrates a concept diagram of a system according to a further example embodiment; and

FIG. 4 illustrates a control flow diagram for charging of a battery pack via a battery charger based on battery data communicated to the battery charger in according to an example embodiment;

FIG. 5 illustrates a control flow diagram for charging of a battery pack via a battery charger based on battery data communicated to the battery charger in according to a further example embodiment;

FIG. 6 illustrates a control flow diagram for charging of a battery pack via a battery charger based on battery data communicated to the battery charger in according to an even further example embodiment;

FIG. 7 illustrates a control flow diagram for charging of a battery pack via a battery charger based on battery data communicated to the battery charger in according to an even further example embodiment; and

FIG. 8 illustrates a method for charging a battery pack according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Example embodiments provided herein enable a greater charging efficiency of a battery pack therefore leading to a longer-lasting battery pack. Charging a battery pack each time to its full capacity will expose the battery pack to heat and charging power that may lead to expedited aging of the battery pack. Furthermore, if a user of the tool is always waiting on an alert that indicates the battery is fully charged to start a task, the user may waste time. To achieve a longer-lasting battery pack and to optimize time spent by the user, example embodiments provide for a battery pack that is configured to at least determine how long it takes a tool to perform a specific task (e.g., mowing the lawn, blowing leaves from the porch, etc.) and then transmit that information to the battery charger such that the battery pack may be charged only long enough to support that task or multiple tasks generally done by the same user. Only charging a battery to a predetermined or desired level that supports the tasks the user tends to complete with a tool leads to a healthier, longer-lasting battery while optimizing time for a user. Accordingly, a battery pack as further described herein may be configured to communicate to the battery charger certain operational data to enable efficient and predictive charging of the battery pack by a battery charger to a predetermined or desired charge level. Furthermore, the user of the tool may be able to have greater access to this operational data and therefore may be able to optimize their use of the battery pack and tool.

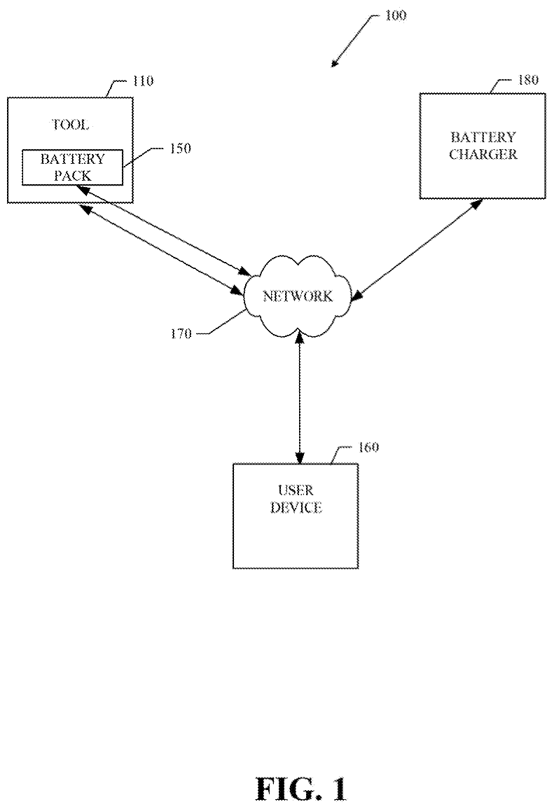

FIG. 1 illustrates a diagrammatic representation of a system that is configured to facilitate communication between a battery pack and a battery charger in order to enable efficient charging of the battery pack by the battery charger to a predetermined or desired charge level. The system 100 is an example embodiment in which a rechargeable battery pack 150 and corresponding battery charger 180 may operate. As shown in FIG. 1, the system 100 may include a battery-powered tool 110. The tool 110 may be configured to be powered by and communicate with the rechargeable battery pack 150. The battery pack 150 may be configured to be recharged by and communicate with the battery charger 180. In this regard, the battery pack 150 may communicate with the battery charger 180 while powering the tool 110, and in some cases, while being charged on or transferred to the battery charger 180.

It should be appreciated that example embodiments may be practiced in connection with any tool 110 that may benefit from having a rechargeable battery pack 150, as discussed herein. For example, the tool 110 may be an outdoor power equipment tool. The outdoor power equipment tool may be a mower, a blower, a chainsaw, a trimmer, an edger, a snow removal tool, a tiller, or the like. Furthermore, it should be understood that the battery pack 150 may be configured to operate in a plurality of different types of tools 110. For example, the battery pack 150 may be configured to power a mower, trimmer, and blower or the like owned by the same user. Accordingly, a plurality of tools 110 may be configured to be powered by the same or a same type of battery pack 150. In this regard, any battery-powered tool 110 that can be operably coupled to the battery pack 150 for both power provision purposes and communication purposes, as described herein, may be part of the system 100, and the system 100 could include as few as a single tool 110 or as many as dozens of tools 110.

As mentioned above, the battery pack 150 may be configured to communicate with the battery charger 180 while installed for powering the tool 110, and while being charged by the battery charger 180. In accordance with some example embodiments, however, the battery pack 150 may also communicate with the battery charger 180 when not installed or being charged. To facilitate interaction with both the tool 110 and the battery charger 180, the battery pack 150 may include circuitry to enable the battery pack 150 to be charged by the battery charger 180 and to enable the power from the battery pack 150 to be delivered to the tool 110. Furthermore, the battery pack 150 may include circuitry that enables the battery pack 150 to communicate directly or indirectly with the tool 110 and the battery charger 180. Thus, the battery pack 150 may be configured to be operably coupled to each of the tool 110 and the battery charger 180 on two levels at certain times, as discussed further herein (e.g., power transfer level and data communication level).

With regards to the operably coupling of the battery pack 150 to each of the tool 110 and the battery charger 180, there may be a power transfer level of connectivity, and secondly there may be a data communication level of connectivity. As such, with respect to the tool 110, the battery pack 150, may, for example, both provide power to the tool 110 and communicate with and gather information from the tool 110. With respect to the battery charger 180, the battery pack 150, can, for example, both receive power to be charged and communicate with and transfer information gathered from the tool 110 (e.g. via a network 170) for efficient and predictive charging and use of the battery pack 150 and the tool 110.

In accordance with example embodiments herein, the battery pack 150 may be configured to communicate with the battery charger 180 and the tool 110 in order to optimize the charging of the battery pack 150 and therefore the user's experience with the tool 110. In this regard, the battery pack 150 may be configured to gather certain operational parameters or data about the tool 110 in order to optimize charging time of the battery pack 150 and the user's experience with the tool 110. Accordingly, in order to enable efficient charging and use of the battery pack 150 and the tool 110, the battery pack 150 may be configured to extract information about the operation of the tool 110 (e.g., operational parameters) that are both related to the power provision function of the battery pack 150 and unrelated to the power provision function of the battery pack 150. Thus, for example, the battery pack 150 may be configured to simultaneously power the tool 110, manage the power provision or charging, extract information from the tool 110 regarding charging and use activity and provide the extracted information to the network 170 in order for that information to be communicated to the battery charger 180, and in some cases, a user device 160 (or any other device located on the network 170). For example, the information gathered from the tool 110 via the battery pack 150 may be transmitted to the user device 160 of the user via the network 170 so the user may be enabled to appreciate certain performance characteristics of the tool 110 and the battery pack 150 or otherwise interact with the tool 110 or the battery pack 150 to enhance maintenance, management or otherwise enhance the user experience. It should be understood that the battery pack 150 is disclosed as gathering the operational parameters related to the tool 110 and transmitting the data gathered to the battery charger 180 and user device 160, but in some cases, the tool 110 itself may record and gather the operational parameters and then transmit the operational parameters to the battery charger 180 or the user device 160.

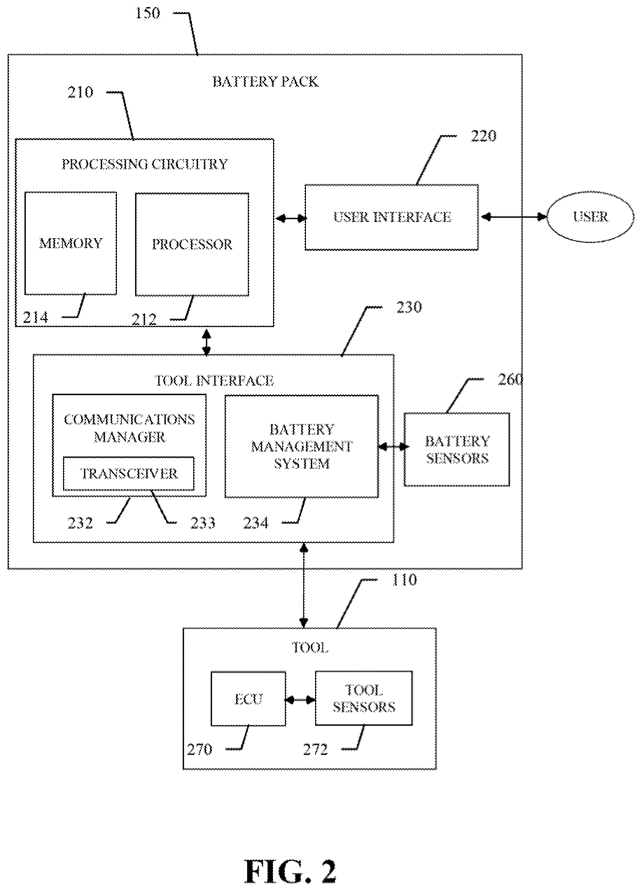

FIG. 2 illustrates a block diagram of processing circuitry of the battery pack 150 in accordance with an example embodiment. It should be understood that the battery pack 150 discussed herein may include housing (not shown) which may encase one or more battery cells (e.g., of type 21700) therein. Furthermore, in some cases, the battery pack 150 may have a voltage of about 36V and may be a lithium ion battery pack.

As shown in FIG. 2, the battery pack 150 may include or otherwise be in communication with processing circuitry 210 that may be configurable to perform actions in accordance with example embodiments described herein. The battery pack 150 may include processing circuitry 210 of an example embodiment as described herein. In this regard, for example, the battery pack 150 may utilize the processing circuitry 210 to provide electronic control inputs to one or more functional units of the battery pack 150 and to process data received at or generated by the one or more functional units regarding various indications of tool activity (e.g., operational parameters or location information) relating to the tool 110. In some cases, the processing circuitry 210 may be configured to perform data processing, control function execution or other processing and management services according to an example embodiment. However, in other examples, the processing circuitry 210 may be configured to manage extraction, storage or communication of data received at the processing circuitry 210.

In some embodiments, the processing circuitry 210 may be embodied as a chip or chip set. In other words, the processing circuitry 210 may comprise one or more physical packages (e.g., chips) including materials, components or wires on a structural assembly (e.g., a baseboard). The structural assembly may provide physical strength, conservation of size, or limitation of electrical interaction for component circuitry included thereon. The processing circuitry 210 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 210 may include one or more instances of a processor 212 and memory 214 that may be in communication with or otherwise control other components or modules that interface with the processing circuitry 210. As such, the processing circuitry 210 may be embodied as a circuit chip (e.g., an integrated circuit chip) configured (e.g., with hardware, software or a combination of hardware and software) to perform operations described herein. However, in some embodiments, the processing circuitry 210 may be embodied as a portion of an on-board computer housed in the battery pack 150 with a battery management system (BMS) 234 or communications manager 232 to control operation of the battery pack 150 relative to its interaction with other tools.

Although not required, some embodiments of the battery pack 150 may employ a user interface 220. The user interface 220 may be in communication with the processing circuitry 210 to receive an indication of a user input at the user interface 220 or to provide an audible, visual, tactile or other output to the user. As such, the user interface 220 may include, for example, a display, one or more switches, lights, buttons or keys (e.g., function buttons), or other input/output mechanisms. In an example embodiment, the user interface 220 may include one or a plurality of colored lights or a simple display to indicate charge status or other relatively basic information. However, more complex interface mechanisms could be provided in some cases.

As shown in FIG. 2, the battery pack 150 may further include the BMS 234 and the communications manager 232. The BMS 234 and the communications manager 232 may be embodied as or otherwise controlled by the processing circuitry 210. However, in some cases, the processing circuitry 210 may be associated with only a specific one of the BMS 234 or the communications manager 232, and a separate instance of processing circuitry may be associated with the other. Yet in some cases, the processing circuitry 210 could be shared between the BMS 234 and the communications manager 232 or the processing circuitry 210 could be configured to instantiate both such entities. Thus, although FIG. 2 illustrates such an instance of sharing the processing circuitry 210 between the BMS 234 and the communications manager 232, it should be appreciated that FIG. 2 is not limiting in that regard.

Each of the BMS 234 and the communications manager 232 may employ or utilize components or circuitry that acts as a tool interface 230. The tool interface 230 may include one or more interface mechanisms for enabling communication with other tools or devices (e.g., tool 110, the battery charger 180, the user device 160, or internal components of the battery pack 150). In some cases, the tool interface 230 may be any means such as a device or circuitry embodied in either hardware, or a combination of hardware and software that is configured to receive or transmit data from/to components in communication with the processing circuitry 210 via internal communication systems of the battery pack 150. With respect to the communications manager 232, the tool interface 230 may further include wireless communication equipment (e.g., a one way or two way radio) for at least communicating information from the battery pack 150 to the battery charger 180 or user device 160. As such, the device interface 230 of the communications manager 232 may include an antenna and radio equipment for conducting Bluetooth, WiFi, or other short range communication, or for employing other longer range wireless communication protocols for communicating with the battery charger 180 or user device 160 (via the network 170) in instances associated with access to a wide area network. It should be understood that network 170 may also mean a direct connection between respective devices.

The processor 212 may be embodied in a number of different ways. For example, the processor 212 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry in the form of processing circuitry 210) capable of performing operations according to embodiments of the present invention while configured accordingly. Thus, for example, when the processor 212 is embodied as an ASIC, FPGA or the like, the processor 212 may be specifically configured hardware for conducting the operations described herein. Alternatively, as another example, when the processor 212 is embodied as an executor of software instructions, the instructions may specifically configure the processor 212 to perform the operations described herein.

In an example embodiment, the processor 212 (or the processing circuitry 210) may be embodied as, include or otherwise control the operation of the battery pack 150 based on inputs received by the processing circuitry 210. As such, in some embodiments, the processor 212 (or the processing circuitry 210) may be said to cause each of the operations described in connection with the battery pack 150 in relation to operation of the battery pack 150 relative to undertaking the corresponding functionalities associated therewith responsive to execution of instructions or algorithms configuring the processor 212 (or processing circuitry 210) accordingly.

In an example embodiment, the memory 214 may include one or more non-transitory memory devices such as, for example, volatile and/or non-volatile memory that may be either fixed or removable. The memory 214 may be configured to store information, data, applications, instructions or the like for enabling the processing circuitry 210 to carry out various functions in accordance with example embodiments. For example, the memory 214 could be configured to buffer input data for processing by the processor 212. Additionally or alternatively, the memory 214 could be configured to store instructions for execution by the processor 212. As yet another alternative or additional capability, the memory 214 may include one or more databases that may store a variety of data sets responsive to input from the tool 110, or any other functional units or devices from which the battery pack 150 has previously extracted data while powering such tool. Among the contents of the memory 214, applications may be stored for execution by the processor 212 in order to carry out the functionality associated with each respective application. In some cases, the applications may include instructions for recognition of patterns of activity and for initiation of one or more responses to the recognition of any particular pattern of activity as described herein. Additionally or alternatively, the applications may prescribe particular reporting paradigms or protocols for reporting of information from the battery pack 150 to a network device (i.e., the battery charger 180 or the user device 160) via the communications manager 232.

In some embodiments, the BMS 234 may be any means such as a device or circuitry embodied in either hardware, or a combination of hardware and software that is configured to receive or transmit battery data (e.g., operational parameters) to/from the tool 110. The BMS 234 may also control or provide electrical connections or interfaces between the battery pack 150 and the tool 110 to monitor power provision parameters and enable the BMS 234 to implement operational, safeguard, or protective functions as appropriate. These functions may be implemented based upon examination of the battery or tool data and comparison of such data to various predefined thresholds or limits. Thus, the battery data may, in some cases, be acted upon locally by the BMS 234. However, alternatively or additionally, the battery data may be provided to the communication manager 232 for transmission to the network 170 (or entities accessible through the network 170). In these and other instances, the battery data may be stored locally prior to such transmission or may be transmitted in real-time (or substantially real-time).

The BMS 234 may receive the battery data (e.g., operation parameters) from one or more battery sensors 260. The battery data may include, for example, information indicative of current draw at discrete intervals, continuously, or at discrete times. Temperature data, maximum current, state of charge, charging condition, and other data related to the battery pack 150 or other aspects of the tool 110 relative to current draw or battery performance may also be included in the battery data. Accordingly, the battery sensors 260 may include, without limitation temperature sensors, current sensors, voltage sensors, or the like. Each of the battery sensors 260 may be a single sensor for the battery pack 150 or a plurality of sensors.

In an example embodiment, the BMS 234 may receive or generate identification information that correlates a specific tool 110 to the user of the tool 110. Thus, all data may be transmitted or stored in association with the identification information so that such data can be associated with its respective tool, tool type, or user for analytical purposes. The identification information may include a specific tool identifier (e.g., serial number), a type identifier indicating the type or model of the tool 110 (e.g., model number), or a specific user identifier (e.g., employee ID).

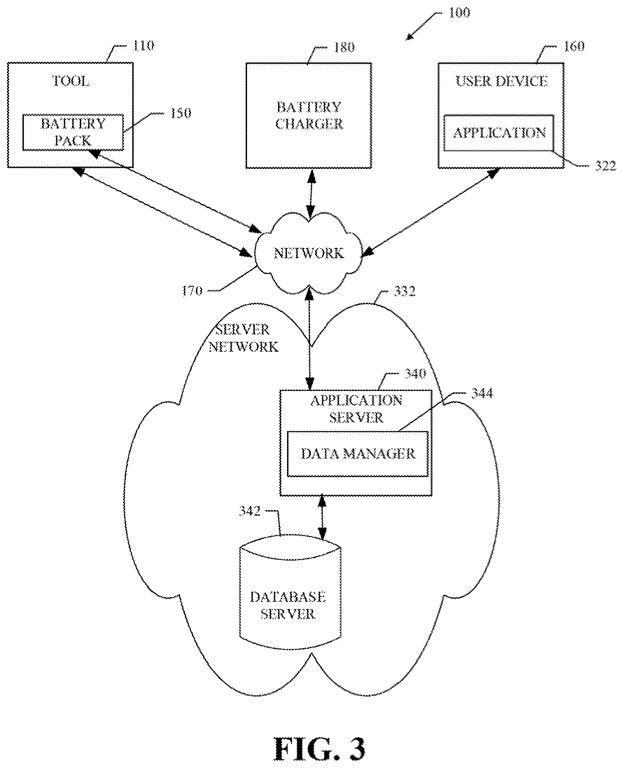

In an example embodiment, the communications manager 232 may be any means such as a device or circuitry embodied in either hardware, or a combination of hardware and software that may be configured to receive or transmit tool data from/to the tool 110. The communications manager 232 may also control the storage or further communication (e.g., relaying) of tool data (e.g., operational parameters) extracted from the tool 110. In this regard, the communication manager 232 may include a transceiver 233 to facilitate communication between the battery pack 150 and any network devices (via the network 170). An engine control unit (ECU) 270 of the tool 110 may receive or generate the tool data based on data received from one or more tool sensors 272, including without limitation, tachometers, accelerometers, torque meters, positioning sensors, or the like. Thus, for example, the tool data may be extracted from the tool 110 to which the battery pack 150 may be operably coupled during such coupling. The extracted operational parameters of the data may then be immediately transmitted (e.g., relayed) to the network 170 for further provision to the battery charger 180 or user device 160 or the extracted operational parameters may be temporarily stored prior to later transmission to the battery charger 180 or the user device 160 via the network 170. The tool data may include information specific to battery and tool performance (at least some of which is not determined based on measuring battery parameters). Thus, for example, the tool data may include engine RPM, working assembly RPM, torque, run time or run hours, position, orientation, temperature data, speed data, mode of operation, lubricating oil pressure or level, water pressure, volume delivered, instances of protective actions, motion, or the like. Data related to RPM or run time or hours or the like may be used to determine how or how long the tool 110 is operated to determine how long the battery pack 150 needs to be charged. In some example embodiments, the tool data may analyzed locally at the battery pack 150. However, in some embodiments, the tool data may instead be analyzed at the battery charger 180 or a server (as discussed in relation to FIG. 3) after provision thereto.

Similar to the battery data, the tool data may also be transmitted or stored in association with the identification information so that all operational parameters are associated with a respective tool, tool type, or user. The identification information may therefore include a specific tool identifier, a type identifier indicating the type or model of the tool 110, or a specific user identifier. In some embodiments, operational parameters may also be transmitted or stored in association with temporal information that may indicate the time (or time period) that the operational parameters were obtained from the tool 110 or the time that the operational parameters were transmitted from the battery pack 150.

The operational parameters may be extracted from the tool 110 by the battery pack 150 at regular intervals, continuously, or as a response to specific predefined stimuli. After extraction, the communications manager 232 may determine whether to store the data temporarily or relay the operational parameters to network 170 in real-time (or substantially in real-time). The relaying may therefore be at the same schedule (e.g., at regular intervals, continuously, or in response to the specific predefined stimuli) as the data extraction occurs or may occur at a different schedule. Thus, for example, if the operational parameters are at least temporarily stored, the communications manager 232 may define a separate interval or period at which to communicate the operational parameters to the network 170 for transfer to network devices. Alternatively or additionally, the communications manager 232 may define different stimuli to trigger transmission of the operational parameters to the network 170.

As an example, in some cases, removal of the battery pack 150 from the tool 110 may trigger immediate transmission of operational parameters stored in the memory 214 of the battery pack 150 to the network 170 for transmission to the battery charger 180 or user device 160. The fact that the transmission occurs from the battery pack 150 means that even after the tool 110 is left unpowered (and therefore incapable of reporting information about the just completed session) the operational parameters associated with the just completed session will be reported by the battery pack 150.

However, if the battery is depleted fully, then the battery pack 150 may not actually be able to transmit the data until power levels are recharged to level sufficient to support transmission of the data. Thus, in some cases, the battery pack 150 may be configured to check to see if operational parameters are available for transmission as soon as recharging of the battery pack 150 is accomplished by the battery charger 180 to a predetermined or desired charge level to support transmission of the data. Thus, for example, if removal generally triggers transmission, a transmission instruction may be provided at the communications manager 232. However, the communications manager 232 may determine that the power level of the battery 150 is too low to complete transmission of the operational parameters. Thus, the communications manager 232 may provide the transmission instruction, but monitor battery charge status to determine when the battery pack 150 is sufficiently recharged to support transmission of the operational parameters to carry out the transmission instruction. After battery charge status reaches the predetermined charge level, the communications manager 232 may execute the transmission instruction and report the operational parameters to the network 170 for reporting to the network devices.

Furthermore, an identity based communication trigger may be employed by the battery 150. For example, insertion of the battery pack 150 into the tool 110 may trigger an initial identity query whereby the battery pack 150 obtains identification information, e.g. a tool identifier, from the tool 110. Once the identification information is received, the battery pack 150 may start a data log for operational parameters associated with the identity provided in the identification information. The battery pack 150 may also determine whether the identification information is different from the prior identification determined from the previous battery pack 150 insertion into a tool. In some cases, the transmission instruction may be generated when the comparison of identification information indicates a change in identity. However, as an alternative, the transmission instruction could be generated when the comparison of identification information indicates the same identity.

FIG. 3 illustrates a diagrammatic representation of a system in accordance with a further example embodiment described herein. As discussed above, the battery pack 150 may be configured to receive and manage the operational parameters received from the battery pack 150 and the tool 110 and transmit the operational parameters over the network 170 to the network devices. However, in other example embodiments, components of server network 332 may execute applications for storage or analysis of the tool or battery operational parameters. In this regard, one or more application servers (e.g., application server 340), or a database server 342, together may form respective elements of a server network 332. Although the application server 340 and the database server 342 are each referred to as “servers,” this does not necessarily imply that they are embodied on separate servers or devices. As such, for example, a single server or device may include both entities and the database server 342 could merely be represented by a database or group of databases physically located on the same server or device as the application server 340. The application server 340 and the database server 342 may each include hardware or software for configuring the application server 340 and the database server 342, respectively, to perform various functions. As such, for example, the application server 340 may include processing logic and memory enabling the application server 340 to access or execute stored computer readable instructions for performing various functions. In an example embodiment, one function that may be provided by the application server 340 may be the provision of access to information or services related to the battery pack 150. For example, the application server 340 may be configured to receive the data transmitted by the battery pack 150 (via the network 170). The application server 340 may then be configured to analyze RPM data, tool run hours or time, or various other aspects of the operational parameters to determine patterns of use of the tool 110, charging time of the battery pack 150, or other issues or problems. Furthermore, the application server 340 may be configured to provide an alert to the user or fleet manager and the alert may be descriptive of the data received from the battery pack 150 or tool 110. In some cases, the application server 340 may also determine an expected time for completion of charge based on the charging rate and the current state of charge. Additionally or alternatively, the application server 340 may be configured to determine the expected run time achievable for a specific tool or task based on knowledge of discharge rates for the tool or task and the current state of charge. In some cases, these contents may be stored in the database server 342.

In some embodiments, for example, the application server 340 may therefore include an instance of a data manager 344 comprising stored instructions for handling activities associated with practicing example embodiments as described herein. As such, in some embodiments, the user device 160 may access the data manager 344 online via an application 322 and utilize the services provided thereby. However, it should be appreciated that in other embodiments, the data manager 344 may be initiated from an integrated memory of the user device 160. In some example embodiments, the data manager 344 may be provided from the application server 340 (e.g., via download over the network 170) to the data manager 344 to enable the user device 160 to instantiate an instance of the data manager 344 for local operation. As yet another example, the data manager 344 may be instantiated at the user device 160 responsive to downloading instructions from a removable or transferable memory device carrying instructions for instantiating the data manager 344 at the user device 160. In such an example, the network 170 may, for example, be a peer-to-peer (P2P) network where the data manager 344 includes an instance of the data manager 344 to enable another data manager 344 to act as a server to the user device 160. In a further example embodiment, the data manager 344 may be distributed amongst the user device 160 and the application server 340.

In an example embodiment, the application server 340 may include or have access to memory (e.g., internal memory or the database server 342) for storing instructions or applications for the performance of various functions and a corresponding processor for executing stored instructions or applications. For example, the memory may store an instance of the data manager 344 configured to operate in accordance with an example embodiment. In this regard, for example, the data manager 344 may include software for enabling the application server 340 to communicate with the network 170 or the user device 160 for the provision or receipt of information associated with performing activities as described herein. Moreover, in some embodiments, the application server 340 may include or otherwise be in communication with an access terminal (e.g., a computer including a user interface) via which analysts may interact with, configure or otherwise maintain the system 100.

Furthermore, it should be understood that that applications executable at the application server 340 may include an application for reviewing, monitoring, and/or analyzing individual tool or tool type performance and or battery or battery type performance. In some cases, the applications at the application server 340 may include an application for cloud management of the tool 110. Thus, for example, adaptive battery or tool settings, instructions or the like may be used to specifically configure the tool 110 under specifically identified circumstances or scenarios to maximize control over, for example, a single tool 110 or a fleet of tools 110. In some example embodiments, either the application server 340 or the battery pack 150 may store configuration information specific to the tool 110 or battery pack 150. Thus, for example, the operator may configure the tool 110 in a particular way that is desirable by the specific user of the tool 110. The configuration information may be input at the tool 110 or application 322 and transmitted for storage at the battery pack 150 or the application server 340. The configuration information for the battery pack 150 may be operating conditions, charging limits, temperature limits, charge or discharge rates, or the like (as discussed in more detail below).

Accordingly, the battery pack 150 or the application server 340 or combination thereof may perform analysis of the operational parameters and generate alerts or processed information that is specific to the tool 110. Thus, the operational parameters may then be analyzed for trends or other specific issues and then transmitted to the battery charger 180, and individual users or organizations can receive information specific to their tool 110. However, it should be understood that the information specific to the tool 110 may be benchmarked against the performance of other tools not associated with the individual users or organizations. Thus, the individual users or organizations can determine how hard they run their tools, or how well their battery or tool performs relative to all other equipment monitored by the server network 332. Accordingly, it should be understood that the server network 332 may be used to monitor or receive data from several tools not necessarily owned or operated by the same organization or user (e.g., tools specific to a particular manufacturer or retailer).

Furthermore, as shown in FIG. 3, the user device 160 (a computing device such as personal computer, a cloud based computer, server, mobile telephone, PDA, tablet, smart phone, or the like) may include an application 322 to receive and review data from the server network 322 or the battery pack 150. It should be understood that the user device 160 may include (or otherwise have access to) memory for storing instructions or applications for the performance of various functions and a corresponding processor for executing stored instructions or applications. The user device 160 may also include software or corresponding hardware for enabling the performance of the respective functions of the user device 160 as described below. In this regard, the application 322 may include software for enabling the user device 160 to communicate with the network 170 for requesting or receiving information or data via the network 170. The information or data receivable at the application 322 may include deliverable components (e.g., downloadable software to configure the user device 160, or information for consumption/processing at the user 322). As such, for example, the application 322 may include corresponding executable instructions for configuring the user device 160 to provide corresponding functionalities for enabling the user device 160 to communicate to the user the data received from the battery pack 150 or the tool 110.

Thus, in accordance with example embodiments herein, the battery pack 150 (or in some cases the application server 340) may receive the operational parameters (i.e., the battery or tool data). This battery and tool data may be analyzed by the battery pack 150 or the application server 340 (as discussed above) and then transmitted to the battery charger 180 via the network 170. For example, at a general level, the battery pack 150 may receive information related to a length of a run time of the tool 110 (i.e., from a detected power on condition to a detected power off condition of the tool 110). This run time information may be predictive of a next task of the tool 110. Accordingly, the battery pack 150 may be configured to determine if the remaining charge level, if any, of the battery pack 150 is sufficient to support the next or subsequent task of the tool 110. The determination of whether the charge level is sufficient may then be transmitted to the battery charger 180 such that the battery charger 180 only charges the battery pack 150 to a predetermined or desired level corresponding to the predicted run time associated with the subsequent tasks performed by the tool 110. This determination may be optionally communicated to the user device (via application 322) such that the user has access to the remaining charge level of the battery pack 150 and can determine whether to charge the battery pack 150. However, it should be understood that the battery charger 180 may be configured to not impart any charge on the battery pack if the charge level of the battery pack 150 is communicated as being sufficient to support the subsequent operation of the device unless overridden by the user.

In accordance with other example embodiments, however, the run time or usage data of the tool 110 may be compared to a predetermined number of previous usages or operations of the tool 110 to calculate an average run time of the tool 110. This average run time information may be used as being predictive of a next task of the tool 110. Accordingly, the battery pack 150 may be configured to determine if the remaining charge level, if any, of the battery pack 150 is sufficient to support the next or subsequent task of the tool 110 based on the calculated average run time. The determination of whether the charge level is sufficient may then be transmitted to the battery charger 180 such that the battery charger 180 only charges the battery pack 150 to a predetermined or desired level corresponding to the average run time associated with the subsequent task of the tool 110. In some cases, the average run time may be calculated from data gathered via the server network 322 from several similar tools or devices operated by different users. In other words, the average run time may be based on run time data gathered from similar tools under similar conditions.

In some cases and as discussed above, the user via the user device 160 may input certain operational conditions related to how the tool 110 will be operated to predict and further optimize the charge time of the battery pack 150. For example, the user may input lawn/lot size, ground condition, grass type, etc., and these conditions may be used to configure the tool 110 and battery pack 150 accordingly (via the application server 340, the battery pack 150, etc.). In other words, the user may input these operational conditions such that a charge of the battery pack 150 will be sufficient to support the next or subsequent task performed by the battery pack 150. In some cases, upon manually entering the operational conditions, the application 322 may be configured to notify the user if the battery pack 150 needs to be charged and, if so, the estimated charge time of the battery pack 150 that will be sufficient to accommodate these conditions so the user may plan accordingly.

Furthermore, in some cases, the user may plan on using the battery pack 150 to accomplish several tasks with multiple tools 110 (e.g., mower, blower, trimmer, etc.). For example, the user may plan to accomplish a first task and a second task. The first task may be trimming the perimeter of a lawn for 15 minutes with a battery string trimmer, and the second task may be pruning a small tree (e.g., less than 12 feet tall) with a chainsaw, which may take about 75% of the battery charge level (e.g., corresponding to 3 of the 4 possible LEDs on the battery pack 150). Accordingly, the battery pack 150 may be configured to detect and predict each individual run time of the respective devices 150 (as discussed above) and determine the battery pack charge level (e.g., corresponding LEDs, etc.) that will enable the user to accomplish these tasks.

In this regard, the predetermined charge level that is sufficient to support performing multiple tasks, for example on the same day, may be transmitted to the battery charger 180 such that the battery charger 180 charges the battery pack 150 appropriately. In some cases, the battery pack 150 may be configured to notify the user that multiple battery packs 150 may be needed to support multiple tasks and to charge each battery pack 150 accordingly. In embodiments, where the user may complete several tasks with the same or plurality of tools 110 in a predefined period of time (e.g., over the course of an afternoon or day), the user (via the user device 160) may input an operational plan that includes performing several tasks, or the battery pack 150, based on analysis of operational parameters gathered from previous uses, may predict that the user more likely than not performs several tasks within the predefined period of time and ensure that the battery charger 180 charges the battery pack 150 accordingly. This capability by the system 100 may be particularly useful in applications that involve the management of a fleet of tools 110 used in a commercial setting. A manager of the fleet, for example, may then have the ability to predict how many battery packs 150 will be needed for each day and the charge level needed for each particular battery pack 150 enabling the manager to efficiently optimize the task plan of the fleet for the day.

In accordance with other example embodiments, operational conditions inputted by the user in order to configure the battery pack 150 or the battery charger 180 may be compared to actual data detected at the tool 110 or battery pack 150 or data stored at the server network 332 to determine if adjustments are needed to the next charge of the battery pack 150. In other words, where the user is manually inputting data to control the charge time of the battery pack 150, the system 110 may be configured to make recommendations to the user to ensure the battery pack 150 is charged efficiently and appropriately (e.g., actual conditions detected may be helpful in determining if battery pack charge time should be adjusted up or down).

The calculated charging time of the battery pack 150 discussed herein may not only be based on a run time or usage of the tool or device but may be calculated in combination with any of the rate of travel of the tool 110 (e.g., the rate of travel detected based on tool position over time or a default rate of travel stored by the server network 332), the discharge rate of the battery pack 150 (e.g., the current discharge rate based on the battery data of a default discharge rate for the type of device), or the like. While embodiments discussed above relate to charging time of the battery pack 150, it should be understood that the operational parameters or data detected may be used for communicating to the user an expected range of the tool 110. In this regard, rather than communicating to the user the expected charge time need to support the tasks, the system 110 may be configured to take the current charge level of the battery pack 150 and communicate what tasks/usage can be supported by that charge level.

It should also be understood that the user may have access to the data that is being communicated to the battery charger 180 via the battery pack 150 or the application server 340. For example, the user may be notified (via the application 322 on the user device 160) when the battery pack 150 is done charging, or what the estimated charging time of the battery pack 150 is, or if the battery pack 150 should be charged. In this regard, the battery pack 150 may cause one or more alerts or reports to be displayed on the user device 160 regarding the battery pack charging status. The battery pack charging status may include a charging condition, e.g., whether the battery pack 150 is currently being charged, discharged, or inactive. Additionally or alternatively, the battery charging status may include the state of charge, e.g., the fraction or percentage of charge, of the battery pack 150. In some cases, the charging status may be a text display of the charging condition and or the state of charge textually, for example as a positive sign, negative sign, or no sign in combination with a percentage. In some example embodiments, the charging status may be a visual display, such as an icon or graph, that includes a time until the battery pack 150 reaches a predetermined charge, a total capacity of the battery pack 150, a remaining capacity of the battery pack 150, or the like.

As the data may include data associated with operation of the battery pack 150 including battery output data, current, voltage, power, load, discharge rate, or the like, the user may have access to or receive reports that include battery pack condition data, such as temperature; or battery pack use data, such as number of charging cycles or uses, duration of use, or the like. The other reports associated with the operation of the battery pack 150 may be useful for trend analysis, failure analysis, and or maintenance scheduling. Regardless of the data being communicated to the user, it should be understood that, in some cases, data may be separated by device type or specific device, such as based on a device identifier.

Furthermore, the user may have full control over the charging operation of the battery pack 150. For example, the user may control the time of day the battery charger 180 charges the battery pack 150 (i.e., delayed start) or override any instructions the battery pack 150 has communicated to the battery charger 180. In this regard, the battery pack 150 or tool 110 may be remotely operated via the user device 160. For example, the user device 160 (via the application 322) may be configured to send command signals to the battery charger 180 to activate or deactivate the battery charger 180.

Furthermore, a manufacturer or retailer may have access to the data (e.g., via the server network 332) in order to enable the manufacturer or retailer to make recommendations regarding use of the battery pack 150 or if a different tool 110 or battery pack 150 will enable the user to achieve better performance and further optimize the time spent with the tool 110. The data may also be recorded or stored via the server network 332 so that the data may be transferred to a new battery pack 150 in the event the user replaces the battery pack 150.

As can be appreciated from the example embodiments above, some embodiments may provide a battery pack 150 that can extract operational parameters (e.g., battery pack data or tool data) from tools 110 to which the battery pack 150 is operably connectable (e.g., the tool 110). That extracted information may be transmitted by the battery pack 150 to the battery charger and to other devices or tools (e.g., the user device 160) that may be connected to the network 170 to ensure efficient and optimized charging of the battery pack 150. As discussed, various different communication paradigms and analyses may then be performed on the operational parameters.

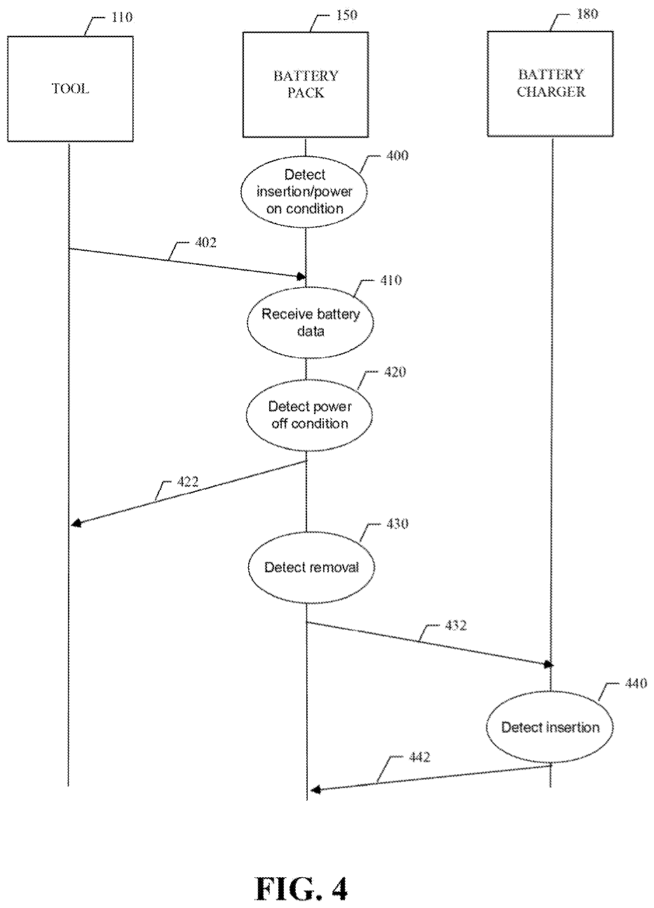

FIGS. 4-7 illustrate various example control flow diagrams illustrating a series of communication operations associated with operation of the battery pack 150 and the battery charger 180 of an example embodiment. As shown in FIG. 4, the battery pack 150 may initially detect insertion into the tool 110 or a power on condition of the tool 110 (e.g., current draw above a predetermined threshold) at operation 400. Thereafter, tool data, may be extracted from the tool 110 by the battery pack 150 at operation 402. Battery data may be received from the BMS 234 of the battery pack at operation 410. The battery data may indicate a power off condition at operation 420 (e.g., current draw below a predetermined threshold). The battery pack 150 may initiate a power off to remove power provision to the tool 110 at operation 422. At operation 430, the battery pack 150 may detect removal from the tool 110. The battery pack 150 may report the operational parameters, e.g., tool data and battery data, and the occurrence of the power off condition to the battery charger 180 (via the network 170) at operation 432. At operation 440, the battery charger 180 may detect insertion of the battery pack 150 into the battery charger 180 for charging in accordance with the parameters received from the battery pack 150. The battery pack 150 may then be charged by the battery charger 180 in accordance with the operational parameters at operation 442.

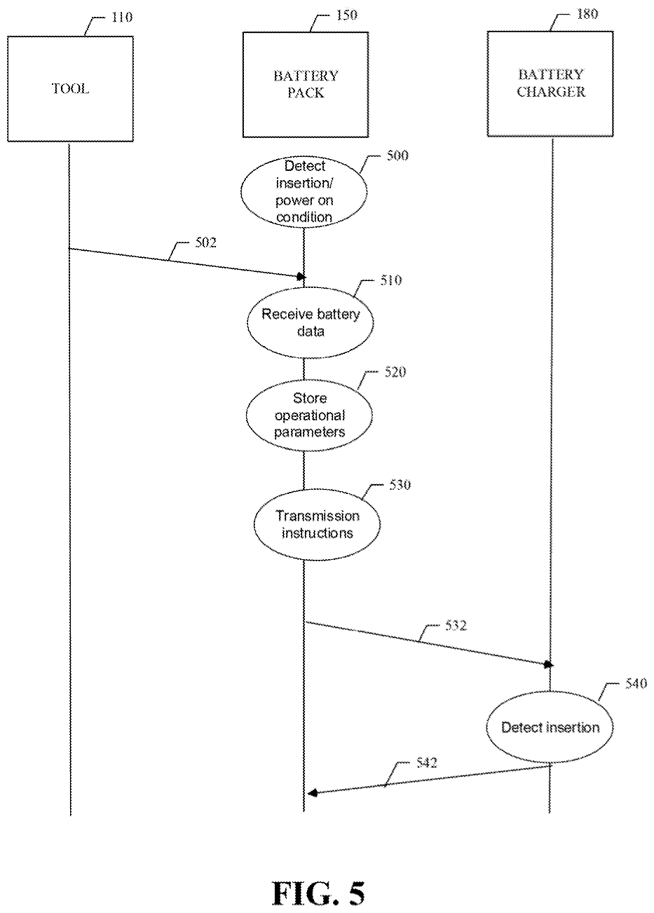

In the example of FIG. 5, the battery pack 150 may initially detect insertion into the tool 110 or a power on condition of the tool 110 (e.g., current draw above a predetermined threshold) at operation 500. Thereafter, tool data may be extracted from the tool 110 by the battery pack 150 at operation 502. Battery data may be received from the BMS 234 of the battery pack 150 at operation 510. Operational parameters, e.g., the tool data or battery data, may be stored in association with identification information of the tool 110 at operation 520. At operation 530, a triggering event may be detected to cause the battery pack 150 to generate or execute a transmission instruction (the transmission instruction being an instruction to transmit the detected parameters to the battery charger 180). At operation 532, the operational parameters or an indication of the triggering event may be transmitted to the battery charger 180. At operation 540, the battery charger 180 may detect insertion of the battery pack 150 into the battery charger 180 for charging in accordance with the parameters received from the battery charger 180. The battery pack 150 may then be charged by the battery charger 180 in accordance with the operational parameters at operation 542.

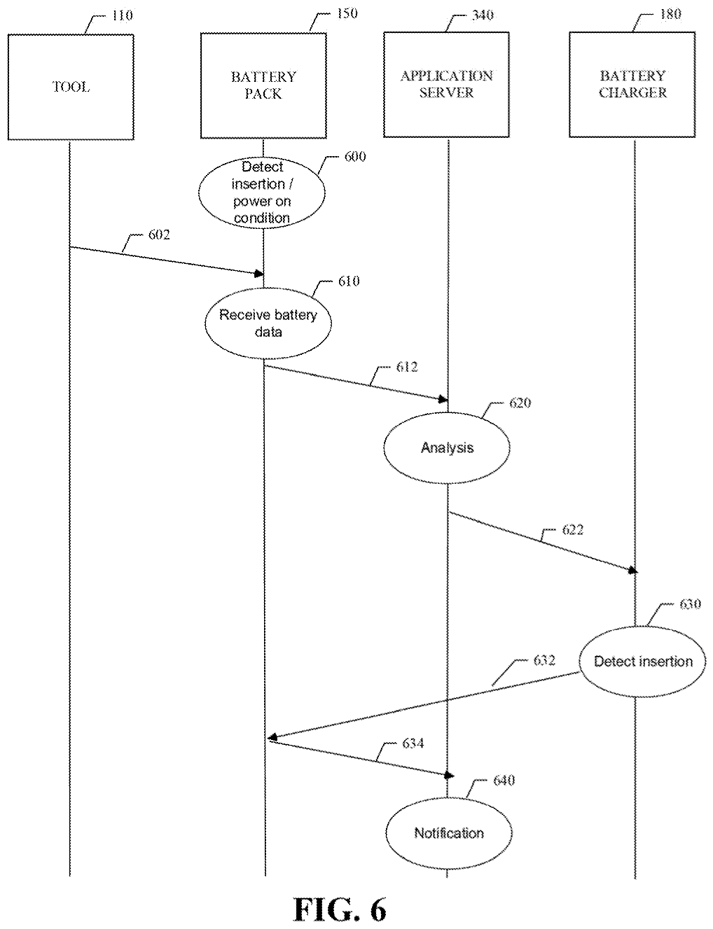

In the example of FIG. 6, the battery pack 150 may initially detect insertion into the tool 110 or a power on condition of the tool 110 (e.g., current draw above a predetermined threshold) at operation 600. Thereafter, tool data may be extracted from the tool 110 by the battery pack 150 at operation 602. Battery data may be received from the BMS 234 of the battery pack at operation 610. Operational parameters, e.g., the tool data or battery data, may be relayed in association with identification information at operation 612 so that the operational parameters are provided in real-time to the application server 340 (e.g., via the network 170) at operation 612. The application server 340 may perform analysis of the operational parameters at operation 620. The application server 340 may then provide the patterns or charging time derived from the operational parameters to the battery charger 180 (e.g., via the network 170) at operation 622. At operation 630, the battery charger 180 may detect insertion of the battery pack 150 into the battery charger 180 for charging in accordance with the parameters received from the application server 340. The battery pack 150 may then be charged by the battery charger 180 in accordance with the operational parameters at operation 632. At operation 634, the battery charger 150 may communicate to the application server 340 that charging is complete. The application server 340 may provide a notification to the user at operation 640 (via the application 322) that the battery pack 150 has been charged and is ready to be used.

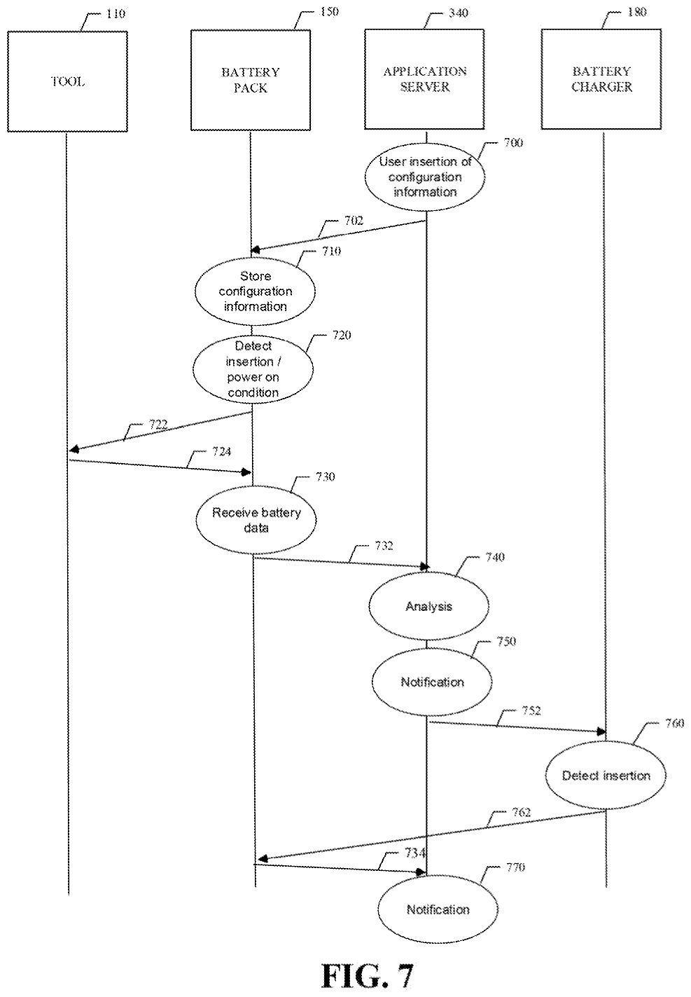

In the example of FIG. 7, the user may insert configuration information of the tool 110 or the battery pack 150 (e.g., operational conditions) into the application 322 of the user device 160 for transmission by the application server 340 in order to configure the tool 110 at operation 700. The application server 340 may provide the configuration information to the battery pack at operation 702. The configuration information may then be stored at the battery pack 150 at operation 710. Thereafter, insertion of the battery pack 150 into the tool 110 for which the configuration information is intended or a power on condition of the tool 110 (e.g., current draw above a predetermined threshold) may be detected at operation 720. The battery pack 150 may then provide the configuration information to the tool 110 to configure the tool 110 accordingly at operation 722. Thereafter, the tool data may be extracted from the tool 110 by the battery pack 150 during device operation in accordance with the configuration information at operation 724. Battery data may be received from the BMS 234 of the battery pack 150 at operation 730. Operational parameters, e.g., the tool data or battery data, may be relayed in association with identification information at operation 732 to the application server 340 (e.g., via the network 170). The application server 340 may perform analysis of the operational parameters at operation 740. The application server 340 may then provide a notification to the user (via the application 322) of the anticipated charging time of the battery pack 150 at operation 750. The application server 340 may then provide the charging time derived from the operational parameters to the battery charger 180 (e.g., via the network 170) at operation 752. At operation 760, the battery charger 180 may detect insertion of the battery pack 150 into the battery charger 180 for charging in accordance with the parameters received from the application server 340. The battery pack 150 may then be charged by the battery charger 180 in accordance with the operational parameters at operation 762. At operation 764, the battery charger 150 may communicate to the application server 340 that charging is complete. The application server 340 may provide a notification to the user at operation 770 (via the application 322) that the battery pack 150 has been charged and is ready to be used.

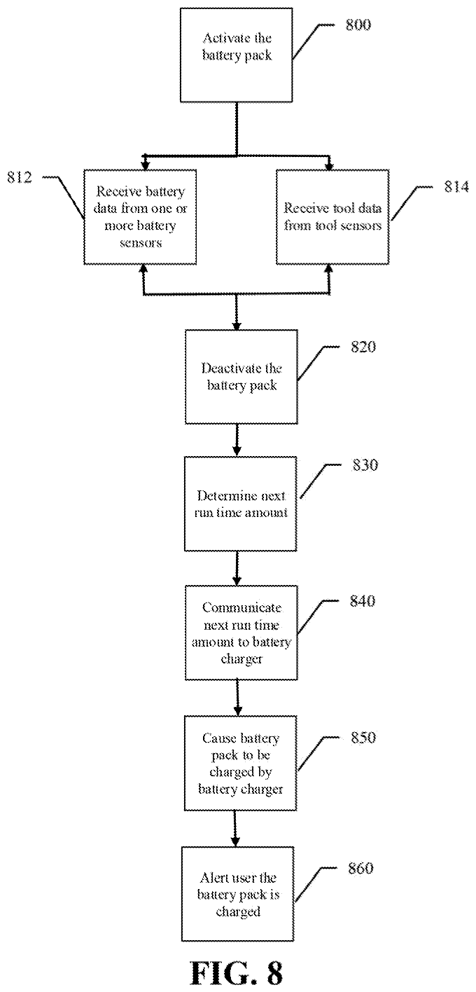

FIG. 8 is a flowchart of a method according to an example embodiment of the system 100. It will be understood that each block of the flowchart, and combinations of blocks in the flowchart, may be implemented by various means, such as hardware, firmware, the processor 212 or the processing circuitry 210 of the battery pack 150, as described in relation to FIG. 2 or similar processing circuitry of the application server 340.

The method may include, activating a battery pack 150 at operation 800 in response to a power on condition or insertion of the battery pack 150 into the tool 110. The method may further include receiving battery data from one or more battery sensors 260 at operation 812 and receiving tool data from tool sensors 272 of the tool 110 at operation 814. The method may also include deactivating the battery pack 150 in response to a power off condition or removal of the battery pack 150 from the tool 110 at operation 820. The method may even further include determining a predicted next run time amount or usage of the tool 110 based on the data received from the battery pack 150 and the tool 110 at operation 830.

The determination of the next run time of the tool 110 may be based on a battery usage profile. The battery usage profile may be a profile based on certain battery usage that corresponds to a certain tool 110, activity, or user. In this regard, in order to determine the next run time of the tool 110, the battery pack 150 may, either through machine learning or input from the user, create a battery usage profile that can be sent to the battery charger 180 that includes when and how much the battery pack 150 should be charged.

When the battery usage profile is derived from machine learning, the battery pack 150, through analyzing any combination of engine RPM, working assembly RPM, torque, run time run hours, position, orientation, temperature data, speed data, mode of operation, lubricating oil pressure or level, water pressure, volume delivered, instances of protective actions, motion, or the like, may determine a schedule of the battery pack 150 in combination with the charge level and use of the battery pack 150 and the particular tool 110 used. In this regard, the battery pack 150 may learn that the user typically mows 2 hours on Friday and then completes leaf blowing and trimming operations for 2 hours on Saturday. Accordingly, the battery usage profile, which contains the usage and times associated with the usage, may be communicated to the battery charger 180 for charging the battery pack 150 appropriately. In some cases, however, the user, through the user application 322, may instruct the battery pack 150 of the schedule of the user. In this case, the battery usage profile may be based on the schedule inputted by the user, and then in accordance with further example embodiments, may be updated by the battery pack 150 based on an analysis of the use of the tool 110. The battery usage profile may also distinguish which particular user is using the device. For example, the battery pack 150 may learn that a first user typically mows 2 hours on Friday and then completes leaf blowing and trimming operations for 2 hours on Saturday and that a second user mows 3 hours on Thursday and completes a trimming operation for 1 hour on Sunday and create a battery usage profile accordingly.

At operation 840, the method may also include communicating the next run time amount to the battery charger 180 in order for the battery pack 150 to be charged in accordance with the predicted amount, and then causing the battery charger 180 to charge the battery pack 150 in accordance with the instructions received from the battery pack 150 at operation 850. The method may further include communicating an alert to a user of the tool 110 that the battery pack 150 has completed charging at operation 860.

Example embodiments therefore represent a battery pack configured to power a device. The battery pack may include processing circuitry configured to receive and analyze operational data associated with the device and the battery pack. The processing circuitry may be further configured to determine a battery pack charge level to support a next operation of the device based on the operational data.

In some embodiments, additional optional structures or features may be included or the structures/features described above may be modified or augmented. Each of the additional features, structures, modifications, or augmentations may be practiced in combination with the structures/features above or in combination with each other. Thus, some, all or none of the additional features, structures, modifications, or augmentations may be utilized in some embodiments. Some example additional optional features, structures, modifications, or augmentations are described below, and may include, for example, that any of the tool, the battery pack, or the battery charger may be configured to determine the predetermined charge level based on operational data associated with the tool or operational data associated with the battery pack. Alternatively or additionally, the operational data may include a run time of the tool, and determining the predetermined charge level may include corresponding the run time of the tool to a charge level of the battery pack. Alternatively or additionally, the battery pack may include processing circuitry configured to: receive and analyze operational data associated with the tool and operational data associated with the battery pack and determine the predetermined charge level based on the operational data. Alternatively or additionally, the processing circuitry may be further configured to determine if a current charge level of the battery pack is less than the predetermined charge level. Alternatively or additionally, the battery pack may further include a communications manager, where if the processing circuitry of the battery pack determines that the current charge level is less than the predetermined charge level, cause the communications manager to transmit, via a network, the predetermined charge level to the battery charger for charging the battery pack to the predetermined charge level. Alternatively or additionally, in response to insertion of the battery pack, the battery charger may be configured to charge the battery pack in accordance with the predetermined charge level. Alternatively or additionally, the system may further include an application server in data communication with any of the tool, the battery pack, or the battery charger via the network, where the processing circuitry of the battery pack may be further configured to alert the application server upon the battery pack being charged in accordance with the predetermined charge level, and in response to receiving the alert from the battery pack, the application server may be configured to cause an alert on a device of the user. Alternatively or additionally, the system may further include an application server, where the application server may be configured to communicate an average run time of the tool to the battery pack, and where determining the predetermined charge level may include corresponding an average run time of the tool to a charge level of the battery pack. Alternatively or additionally, the processing circuitry may be further configured to detect a power on condition of the tool or determine if the battery pack has been inserted into the tool, and in response to the detection of the power on condition or the determination the battery pack has been inserted into the tool, receive and analyze the operational data associated with the tool and the battery pack. Alternatively or additionally, the processing circuitry may be further configured to detect a power off condition of the tool or determine if the battery pack has been removed from the tool, and in response to the detection of the power off condition or the determination the battery pack has been removed from the tool, stop recording and analyzing the operational data associated with the tool and the battery pack. Alternatively or additionally, the tool may be an outdoor power equipment device.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements or functions, it should be appreciated that different combinations of elements or functions may be provided by alternative embodiments without departing from the scope of the appended claims. In this regard, for example, different combinations of elements or functions than those explicitly described above are also contemplated as may be set forth in some of the appended claims. In cases where advantages, benefits or solutions to problems are described herein, it should be appreciated that such advantages, benefits or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A system comprising:
a tool;
a battery pack configured to power the tool; and
a battery charger configured to charge the battery pack to a predetermined charge level, wherein the predetermined charge level is sufficient to perform a predetermined next task of the tool, and wherein the predetermined charge level is less than a full charge level of the battery pack.

2. The system of claim 1, wherein any of the tool, the battery pack, or the battery charger is configured to determine the predetermined charge level based on operational data associated with the tool or operational data associated with the battery pack.

3. The system of claim 2, wherein the operational data comprises a run time of the tool, and wherein determining the predetermined charge level comprises corresponding the run time of the tool to a charge level of the battery pack.

4. The system of claim 1, wherein the battery pack comprises processing circuitry configured to:
receive and analyze operational data associated with the tool and operational data associated with the battery pack; and
determine the predetermined charge level based on the operational data.

5. The system of claim 4, wherein the processing circuitry is further configured to determine if a current charge level of the battery pack is less than the predetermined charge level.

6. The system of claim 5, wherein the battery pack further comprises a communications manager, wherein if the processing circuitry of the battery pack determines that the current charge level is less than the predetermined charge level, cause the communications manager to transmit, via a network, the predetermined charge level to the battery charger for charging the battery pack to the predetermined charge level.

7. The system of claim 6, wherein in response to insertion of the battery pack, the battery charger is configured to charge the battery pack in accordance with the predetermined charge level.

8. The system of claim 7, wherein the system further comprises an application server in data communication with any of the tool, the battery pack or the battery charger via the network, wherein the processing circuitry of the battery pack is further configured to alert the application server upon the battery pack being charged in accordance with the predetermined charge level, and in response to receiving the alert from the battery pack, the application server is configured to cause an alert on a device of the user.

9. The system of claim 4, wherein the system further comprises an application server, wherein the application server is configured to communicate an average run time of the tool to the battery pack, and wherein determining the predetermined charge level comprises corresponding an average run time of the tool to a charge level of the battery pack.

10. The system of claim 4, wherein the processing circuitry is further configured to detect a power on condition of the tool or determine if the battery pack has been inserted into the tool, and in response to the detection of the power on condition or the determination the battery pack has been inserted into the tool, receive and analyze the operational data associated with the tool and the battery pack.

11. The system of claim 10, wherein the processing circuitry is further configured to detect a power off condition of the tool or determine if the battery pack has been removed from the tool, and in response to the detection of the power off condition or the determination the battery pack has been removed from the tool, stop recording and analyzing the operational data associated with the tool and the battery pack.

12. The system of claim 1, wherein the tool is an outdoor power equipment device.

13. A battery pack configured to power a tool, the battery pack comprising:
processing circuitry configured to:
receive and analyze operational data associated with the tool and operational data associated with the battery pack; and
determine, based on the operational data of the tool and the battery pack, a predetermined charge level of the battery pack sufficient to perform a predetermined next task of the tool, wherein the predetermined charge level is less than a full charge level of the battery pack.

14. The battery pack of claim 13, wherein the operational data comprises a run time of the tool, and wherein determining the predetermined charge level comprises corresponding the run time of the tool to a charge level of the battery pack.

15. The battery pack of claim 13, wherein the processing circuitry is further configured to determine if a current charge level of the battery pack is less than the predetermined charge level.

16. The battery pack of claim 15, wherein the battery pack further comprises a communications manager, wherein if the processing circuitry of the battery pack determines that the current charge level is less than the predetermined charge level, cause the communications manager to transmit, via a network the predetermined charge level to a battery charger for charging the battery pack to the predetermined charge level.

17. The battery pack of claim 16, wherein the operational data comprises a run time of the device, and wherein determining the battery pack charge level to support the next operation of the device comprises corresponding the run time of the device to a charge level of the battery pack.

18. The battery pack of claim 13, wherein the processing circuitry is further configured to detect a power on condition of the tool or determine if the battery pack has been inserted into the tool, and in response to the detection of the power on condition or the determination the battery pack has been inserted into the tool receive and analyze the operational data associated with the tool and the battery pack.

19. The battery pack of claim 18, wherein the processing circuitry is further configured to detect a power off condition of the tool or determine if the battery pack has been removed from the tool, and in response to the detection of the power off condition or the determination the battery pack has been removed from the tool, stop recording and analyzing the operational data associated with the tool and the battery pack.

20. (canceled)

21. A method for determining a predetermined charge level of a battery pack configured to power a tool, the method comprising:
receiving and analyzing operational data associated with the tool and operational data associated with the battery pack; and
determining, based on the operational data of the tool and the battery pack, the predetermined charge level of the battery pack sufficient to perform a predetermined next task of the tool wherein the predetermined charge level is less than a full charge level of the battery pack.
